(19) United States
(12) Patent Application Publication
(10) Pub. No.: US 2011/0015795 A1
(43) Pub. Date: Jan. 20, 2011

(54) Smart Outlet with Valid Plug Management and Activation

(75) Inventors: J. Wayne Boyer, Portland, OR (US); John O. George, III, North Plains, OR (US); Roger A. Mach, Beaverton, OR (US)

Correspondence Address: Lieberman & Brandsdorfer, LLC, 802 Still Creek Lane, Gaithersburg, MD, 20878, US

(73) Assignee: INTERNATIONAL BUSINESS MACHINES CORPORATION, Armonk, NY (US)

(21) Appl. No.: 12/504,354

(22) Filed: Jul. 16, 2009

(51) Int. Cl. G06F 19/00

(52) U.S. Cl. 700/286

(57) ABSTRACT

A method and apparatus for managing delivery of power to an electrical outlet to provide safety and security for emission of current from the outlet. The modified outlet is an addressable outlet in communication with a manager for authenticating receipt of a valid appliance, and for limiting delivery of power to the outlet in response to the authentication.

### BACKGROUND OF THE INVENTION

1. Technical Field

This invention relates to an electrical outlet for delivery of electrical power to an electrical appliance. More specifically, the invention relates to granular control of the outlet with respect to delivery of electrical power.

2. Description of the Prior Art

It is recognized that electrical outlets are provided in communication with a source of electrical energy as a means of providing electrical power to electrical devices. An electrical outlet is a receptacle designed to facilitate connections to a wiring system. Each electrical outlet may include one or more jacks as a connecting device in an electrical circuit designed for the insertion of a plug. The standard electrical outlet utilized in the United States is provided with one or more jacks, with each jack having a pair of electrical socket receiving means that are sized to receive a corresponding set of electrical connectors. A third socket is commonly provided for the purpose of grounding, but may not be utilized by all electrical devices. The electrical connectors are a set of blades or prongs that mechanically and electrically connect with the electrical socket receiving means of the jack(s). Upon receipt of the connector by the socket receiving means, electrical energy is delivered to a device in communication with the jack if the electrical circuit is closed. Conversely, if the electrical circuit is open, no electrical energy is delivered to the device. Accordingly, the determination of delivery of electrical energy is at the circuit level and not dependent upon an operating status of the outlet and the jack itself.

It is recognized in the art that as long as the circuit associated with an electrical outlet is closed, the outlet can provide an electric current to a device connected to the jack. Insertion of a plug of an electrical appliance into the jack will result in delivery of power to the device. However, it is not safe or desirable to maintain an electrical outlet in a closed and active state at all times. For example, it is known that people can be harmed by inserting objects into the electrical sockets of an electrical outlet. To mitigate the danger associated with the outlet, different forms of covers and safety apparatus are provided. A residual current device, also known as a ground fault circuit interrupter (GFCI), is known in the art for controlling delivery of electricity to an outlet. The residual current device disconnects a circuit whenever it is determined that the electric current is not in balance. However, aside from a circuit controller and the GFCI, none of the mitigating safety apparatus address delivery of electrical energy to the outlet itself.

One prior art patent, U.S. Pat. No. 4,616,285 to Sackett, addresses safety aspects of an electrical outlet. More specifically, Sackett '285 provides a key to turn the power of the outlet to an on position or an off position. The key is inserted into each individual outlet to provide power to the outlet, or to remove power from the outlet. However, the Sackett '285 patent is limited to employment of the key to regulate power to individual outlets. The key must be inserted into the individual outlet to either remove electric current from the outlet or provide electric current to the outlet. Accordingly, the prior art of Sackett '285 is limited to insertion of a key into each outlet that require the delivery of electric current.

Therefore, there is a need to employ an apparatus and method for regulating delivery of power to an electrical outlet that overcomes the shortcomings of the prior art. More specifically, the solution should address modifying the state of delivery of power to an individual electrical outlet that does not require insertion of a key into each outlet.

### SUMMARY OF THE INVENTION

This invention comprises an apparatus and method for activating an electrical outlet responsive to authentication of at least two connectors of a plug into at least two respective sockets of the outlet.

In one aspect of the invention, a method is provided for controlling delivery of electrical power to a multi-mode electrical outlet. A server is provided in communication with an array of outlets across a communication interface. Each of the outlets in the array is configured with a unique outlet identifier. In addition, each outlet in the array is provided with at least one jack, with each jack in the outlet configured with a unique jack identifier. A message is communicated to the server when an electrical appliance has been received by at least one of the outlets in the array. The outlet authenticates the received electrical appliance with the server. Responsive to authentication by the server, the state of the outlet is changed.

In another aspect of the invention, a system is provided with an array of multi-mode electrical outlets, and a server in communication with the array across a communication interface. An outlet identifier is provided for each outlet in the array. In addition, at least one jack is provided for each outlet in the array, with a jack identifier for each jack in each outlet. A communication interface local to the outlet is employed to send a communication to the server upon receipt of an electrical appliance local to the outlet. An outlet manager, local to the server, receives the communication and authenticates the received appliance with the server. A state of the outlet is changed in response to authentication of the received appliance.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a block diagram of a plurality of electrical outlets in communication with a server.

FIG. 2 is a flow chart demonstrating employment of a server for monitoring the state of an outlet.

FIG. 3 is a flow chart illustrating communication exchange between the server and one or more outlets within a network communication protocol.

FIG. 4 is a flow chart illustrating employment of a schedule for modifying the outlet settings.

FIG. 5 is a flow chart illustrating a process for employing the plug identifier as a layer within the addressable configuration of the outlet.

FIG. 6 is a flow chart illustrating a process for employing non-volatile memory of an outlet to control delivery of power to a received appliance.

FIG. 7 is a block diagram illustrating placement of an outlet manager and it's associated modules in a computer system.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of recovery manager, authentication module, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

An addressable electrical outlet is provided with one or more addressable jacks for validating receipt of a plug into at least one of the respective jacks. In response to the validation, power is delivered to the outlet, and to the connectors of the plug received by the jack(s) of the outlet. The electrical outlet includes different states of operation, and a remote control mechanism for changing the state of the outlet. Similarly, each jack within an outlet includes different states of operation, and a remote control mechanism for changing the state of the jack. Accordingly, the configurable outlet and/or jack controls delivery of power from a remote location to a plug received by the outlet.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the spirit and scope of the present invention.

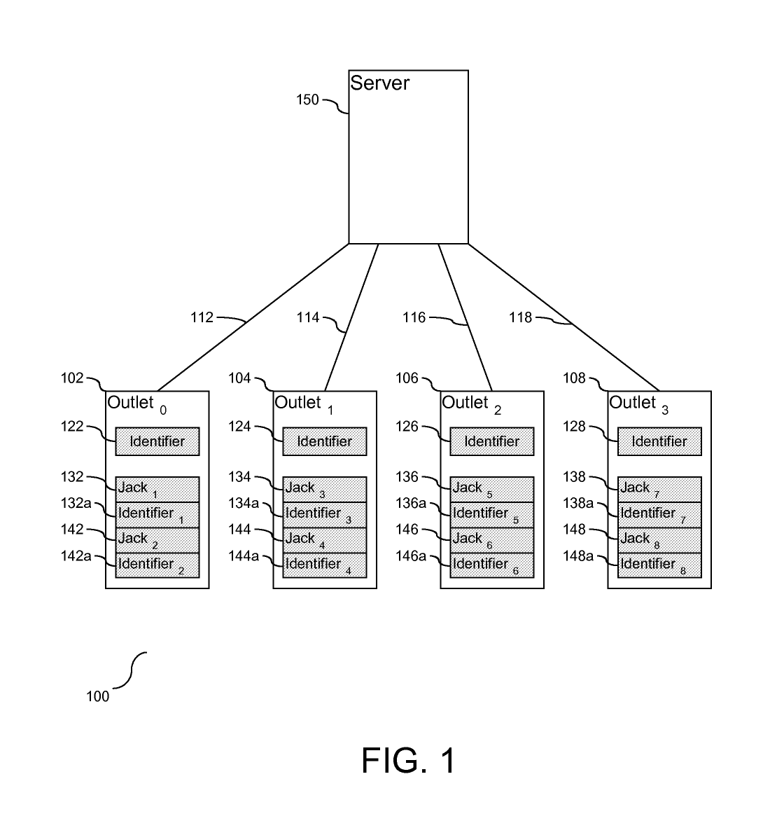

FIG. 1 is a block diagram (100) of a plurality of electrical outlets in communication with a server. As shown, there are four electrical outlets (102), (104), (106) and (108). Each of the outlets is in communication with a server (150), through a communication line. More specifically, outlet (102) is in communication with the server (150) through communication line (112), outlet (104) is in communication with the server (150) through communication line (114), outlet (106) is in communication with the server (150) through communication line (116), and outlet (108) is in communication with the server (150) through communication line (118). Although physical communication lines are shown herein, in one embodiment, wireless communication lines may be employed between the server and each outlet. In the case of a wireless communication line, each outlet is configured with a wireless network adapter that facilitates wireless communication between the outlet and the server (150). Furthermore, although only four outlets are shown herein in communication with the server (150), the invention should not be limited to this quantity. In one embodiment, there may be a larger quantity or smaller quantity of outlets in communication with the server. Each of the outlets (102)-(108) is an addressable outlet and is provided with an identifier. More specifically, outlet (102) is provided with identifier (122), outlet (104) is provided with identifier (124), outlet (106) is provided with identifier (126), and outlet (108) is provided with identifier (128). In one embodiment, each separate identifier is uniquely defined. The employment of the identifiers enables the outlets to be separately addressable by the server (150).

In addition to the addressable outlets, in one embodiment each outlet may be configured with one or more separately addressable jacks. As shown herein, outlet (102) has two jacks (132) and (142) with jack (132) having identifier (132a) and jack (142) having identifier (142a). Similarly, outlet (104) has two jacks (134) and (144) with jack (134) having identifier (134a) and jack (144) having identifier (144a), outlet (106) has two jacks (136) and (146) with jack (136) having identifier (136a) and jack (146) having identifier (146a), and outlet (108) has two jacks (138) and (148) with jack (138) having identifier (138a) and jack (148) having identifier (148a). Although each outlet shown herein is configured with two jacks, in one embodiment, each outlet may be configured with a single jack or additional jacks. Regardless of the quantity of jacks provided per outlet, each jack is individually identifiable and addressable. With the granularity of addressing the jacks within the outlet, each jack may be set to operate in a different state within the same outlet.

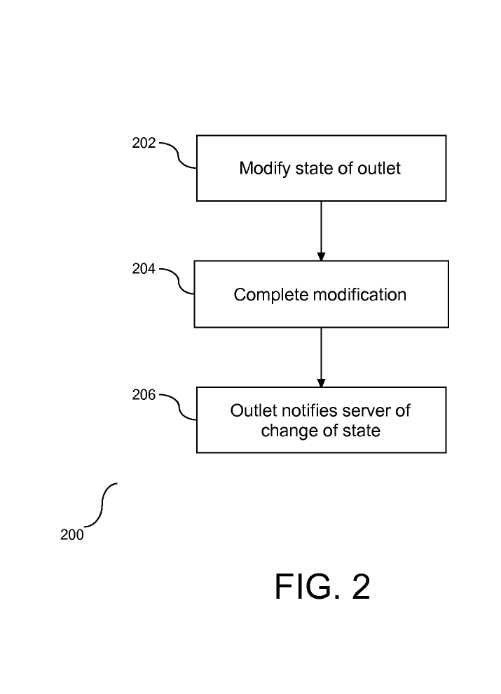

As shown herein, each addressable outlet (102)-(108) is in communication with a server (150), which functions as an interface for configuration of the outlets and associated jacks thereof. In one embodiment, the server (150) is in communication with a visual display (160) which is employed to visually convey the state of each outlet and associated jack. More specifically, the server (150) is employed to manage the state of the outlets and jack. The electrical outlet includes different states of operation, with each of the different states has different operating characteristics, with some of the states having more stringent operating conditions than other states. In one embodiment, the outlet may operate in at least one of five states of operation. Each state provides granular control of power delivery to the outlet and safety from unauthorized use of the outlet. The five states of operation include: off and unlocked, on and insecure, off and locked, on and secure, and off and locked after timeout. Each of the states employs different aspects of safety and security associated with use of the outlet. FIG. 2 is a flow chart (200) demonstrating employment of the server (150) for monitoring the state of an outlet. A tool is invoked local to the outlet to modify the state of operation of the outlet (202). In one embodiment, the tool may be in the form of a key. Upon completing the modification (204), the outlet sends a communication to the server for notification of the change of state (206). In one embodiment, the tool may be employed to modify the state of one or more jacks in communication with the outlet. Accordingly, the tool in combination with the server enables the server to receive notification of a change of state of an outlet and/or jacks in communication with the server.

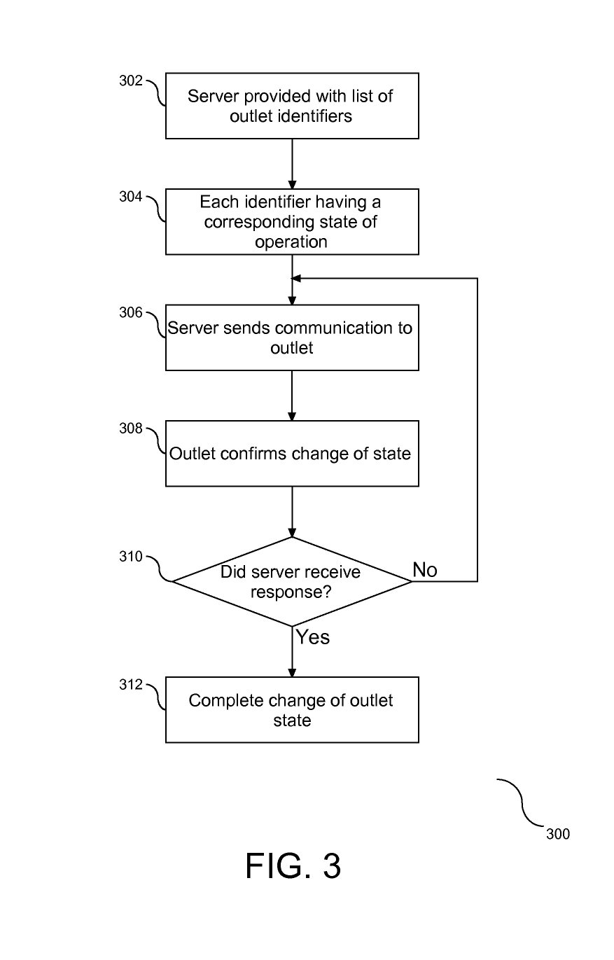

The embodiment shown in FIG. 2 demonstrates employment of the server as a communication tool for tracking the state of an outlet and/or jack as modified by a tool local to the outlet. However, the server may be employed as an interactive tool to facilitate control of the state of the outlet and/or jack separate from or in conjunction with the local state modification tool. FIG. 3 is a flow chart (300) illustrating communication exchange between the server and one or more outlets within a network communication protocol. The server is provided with a list of outlet identifiers (302), with each identifier having a corresponding state of operation of the outlet (304). The server has the ability to modify the state of any individual outlet within the list provided. To change the state of an outlet, the server sends a communication to a specific outlet as identified by the outlet identifier (306). Following receipt of the communication, the outlet sends a response communication to the server to confirm the change of state of operation (308). In one embodiment, until the server confirms receipt of the response communication, the state of the outlet is not changed. To confirm the change of state, it is determined if the server is in receipt of the response communication (310). A negative response to the determination at step (310) is followed by a return to step (306) to repeat the initial request or to attempt to change the state of a different outlet. Conversely, a positive response to the determination at step (310) is followed by completion of the change of state of the subject outlet (312). Although the server is shown in communication with addressable outlets, the functionality of the server may be expanded to include modification of the state of operation of addressable jacks in the network. Accordingly, the server may be employed as a tool to modify the state of operation of individual addressable outlets and/or jacks.

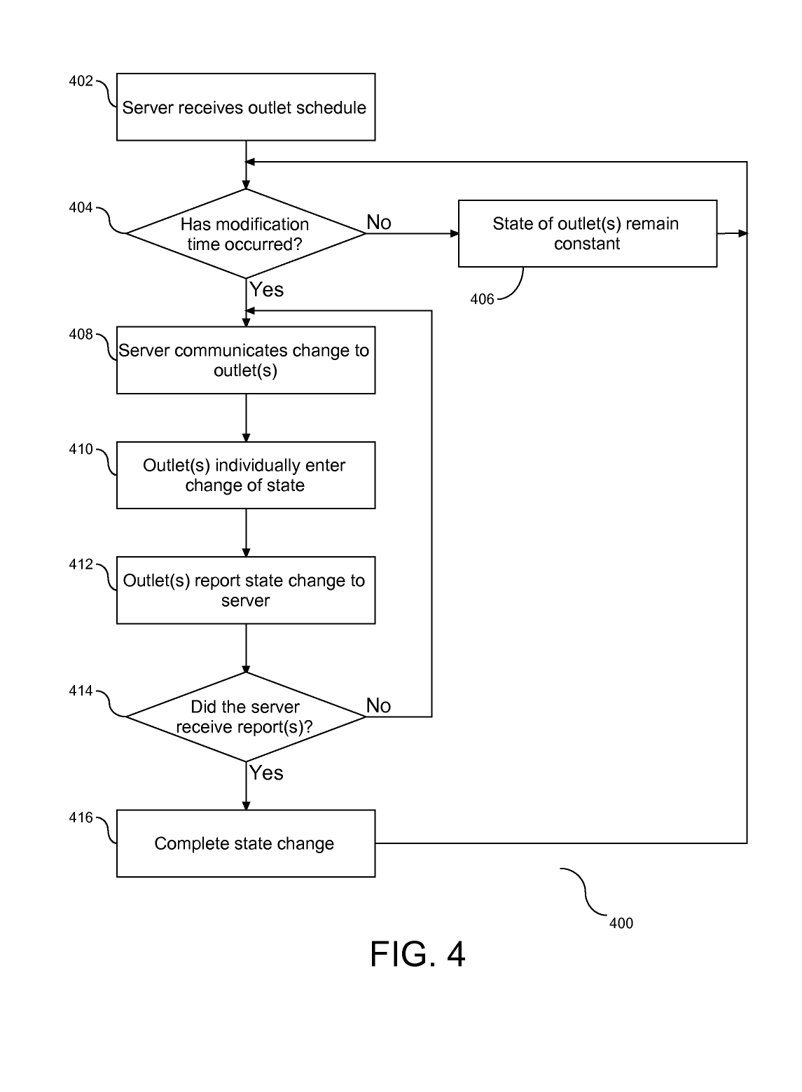

As shown in FIG. 3, the server is employed to separately modify the state of operation of an outlet. The functionality of the server may be expanded to modify the outlet state settings on a schedule. More specifically, a schedule may be employed to communicate events to the outlets in the network. One example of use of the schedule modification tool is for vacation settings. FIG. 4 is a flow chart (400) illustrating employment of a schedule for modifying the outlet settings. As shown, the server receives a schedule of the state of operation of the outlets (402). Based upon the passage of time, it is determined if the time for modification of any of the outlets has occurred (404). A negative response to the determination at step (404) is followed by the state of the outlets remaining constant (406) and a return to step (404). Conversely, a positive response to the determination at step (404) is followed by the server communicating an event to each of the outlets designated for a change of state at the subject time (408). Upon receipt of the event by each of the outlets, the outlets individually enter the change of state (410) and report the state change to the server (412). Following step (412), it is determined if the server is in receipt of the communication (414) from step (412). A negative response to the determination at step (414) is followed by a return to step (408). Conversely, a positive response to the determination at step (414) is followed by completion of the state change of each of the designated outlets at the subject time (416). Since the server is operating on a schedule, the process does not conclude following step (416). Rather, the process returns to step (404) to monitor operation of the schedule for the next change of state of one or more of the outlets. The schedule may be employed to modify the state of the outlets based upon the year, month, day, hour, minute, etc. Accordingly, the server may be in communication with a schedule to individually modify the settings of one or more outlets at pre-defined times.

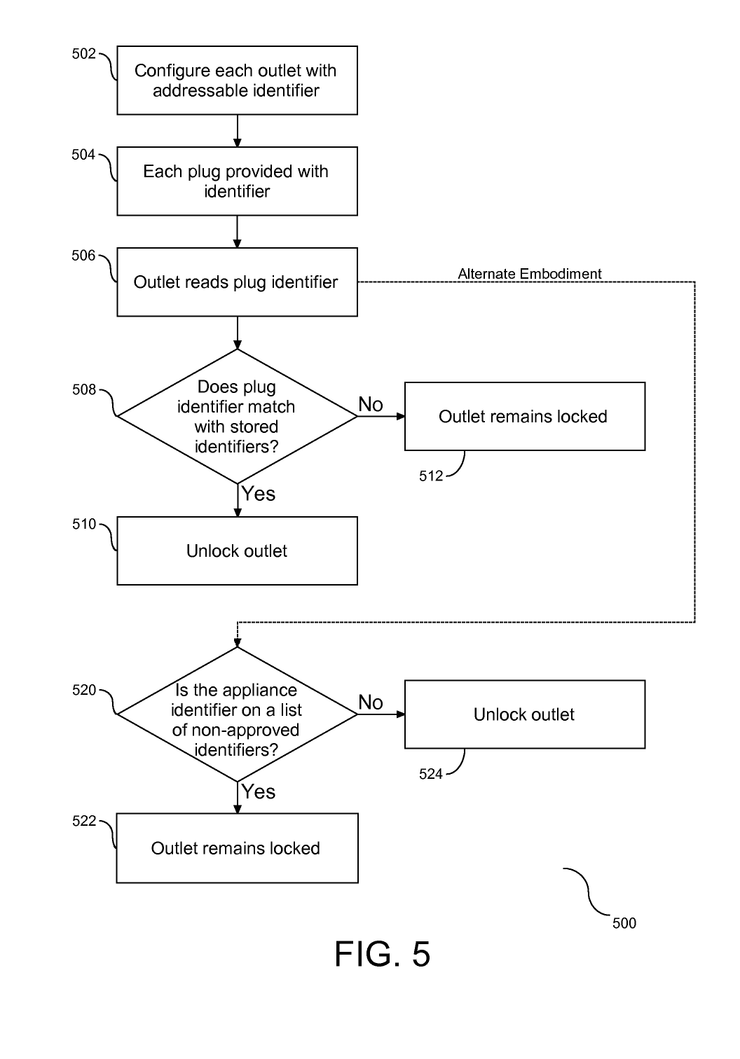

To further enhance the functionality of operation of the outlet, appliance plugs configured to be received by the individual jacks may be modified to include an identifier. FIG. 5 is a flow chart (500) illustrating a process for employing the plug identifier as a layer within the addressable configuration of the outlet. Initially, each outlet is in a locked state wherein power is not delivered to the outlet. Power may be restored to the outlet placing the outlet in an unlocked state upon receipt and verification of an approved appliance. Each outlet is configured with an addressable identifier (502). Similarly, each plug configured to be received by the outlet is provided with an addressable identifier (504). Upon receipt of the appliance plug by the jack, the outlet reads the plug identifier (506). In one embodiment, the plug may be provided with a radio frequency tag with an associated identifier, known as an RFID tag. However, the plug identifier should not be limited to an RFID tag. In one embodiment, an alternative identification element may be employed to provide an addressable identifier to the plug. Similarly, in one embodiment, the RFID tag may be embodied within an appliance in communication with the plug. The server in communication with the outlet is configured with a list of approved appliances, as identified by appliance identifiers. Following step (506), it is determined if the received identifier matches an identifier stored local to the server (508). A positive response to the determination at step (508) unlocks the outlet (510) and enables power to be delivered to the appliance. Conversely, a negative response to the determination at step (508) is an indication that the received plug is not authorized to operate on the subject outlet. As such, the outlet remains locked (512) and power is not delivered to the received appliance. Accordingly, the server may be configured with a list of approved appliances which may enable the server to unlock the outlet in response to a match of the appliance identifier with an identifier on the list of approved appliances.

In addition to providing a list of appliances approved for communication with the outlet, in one embodiment, the server may be configured with a list of appliances approved for communication with one or more addressable jacks. As noted above, each jack in communication with an outlet is configured to receive an individual plug, and each outlet may include one or more jacks. The functionality as demonstrated in FIG. 5 may be extrapolated to include a list of approved appliance identifiers for each individually represented jack identifier. The jack would be unlocked in response to a match of the appliance identifier with the jack identifier.

Similarly, the embodiment shown in FIG. 5 employs a list of appliances as approved by the outlet, which would enable the server to change the state of the jack between locked to unlocked. However, in one embodiment, the list of appliances maintained by the server may be inversely configured, wherein the list would indicate those appliances to which the outlet should be locked and prohibited from delivery of power. In this circumstance, following receipt of the appliance plug at step (506), it is determined if the appliance identifier is on the list of appliance identifiers designated not to receive power from the outlet (520). A positive response to the determination at step (520) allows the outlet to remain in a closed state (522). Conversely, a negative response to the determination at step (520) allows the server to unlock the associated outlet so that the subject appliance may receive power (524). In one embodiment, policy determining delivery of power is on a per-outlet basis with the actual mechanism of delivering power achieved by changing the state of one or more jacks in communication with the outlet.

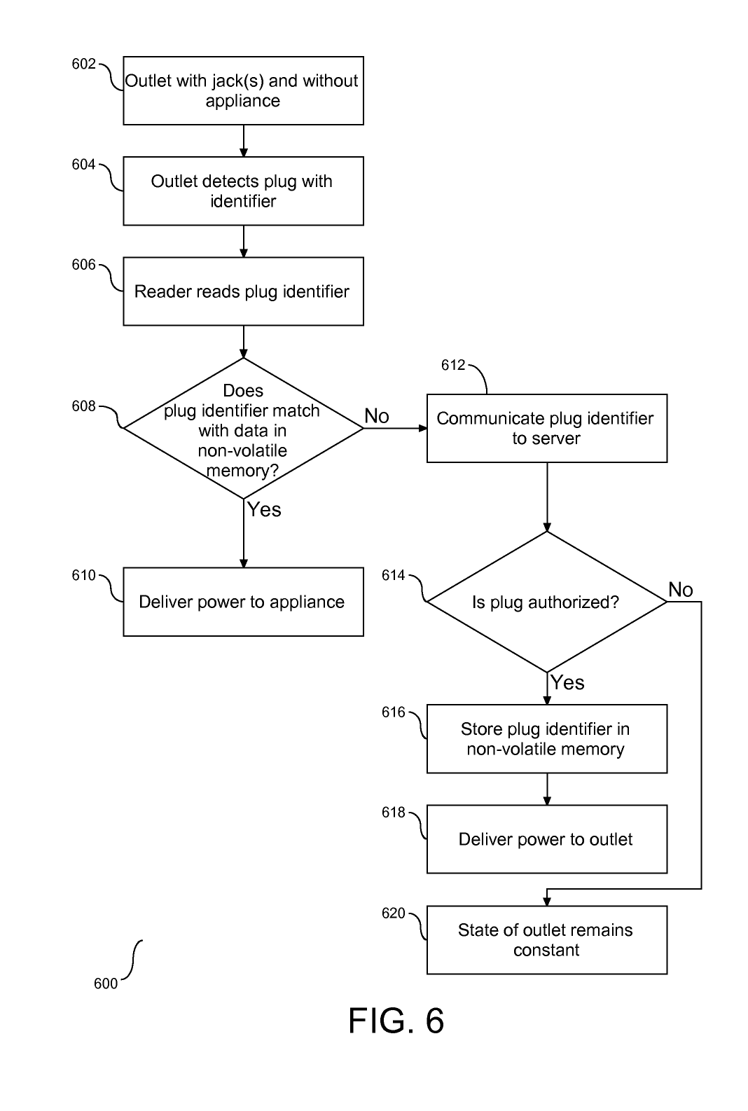

As shown in FIG. 5, each outlet and each jack within each outlet may be controlled for delivery of power on a granular level. Each appliance is configured with an addressable identifier, as is each outlet and/or jack. The server functions as a tool to verify a match of the appliance with the individual jacks and/or outlets in communication with the server. In one embodiment, the outlet may be configured with non-volatile memory to store one or more plug identifiers. FIG. 6 is a flow chart (600) illustrating a process for employing non-volatile memory of an outlet to control delivery of power to a received appliance. An outlet is provided with one or more jacks and without any appliance received in either of the jacks (602). Receipt of a plug with an identifier is detected by the outlet (604). In one embodiment, the detection pertains to plug insertion into the jack. A reader is employed to attempt to read the identifier of the plug (606). In one embodiment, the plug identifier is an RFID tag, and the reader is an RFID tag reader. The outlet in communication with the received appliance compares the received identifier with data retained in non-volatile memory locations in the outlet to determine if there is a match (608). A positive response to the determination at step (608) is followed by delivery of power to the appliance (610). Conversely, a negative response to the determination at step (608) is followed by communication of the plug identifier to the server (612) to determine if the identifier is associated with an authorized appliance (614). A positive response to the determination at step (614) is followed by storage of the plug identifier in the non-volatile storage of the outlet (616) and delivery of power to the outlet (618). Conversely, a negative response to the determination at step (614) is followed by the state of the outlet remaining constant (620). If the outlet is in an on and unlocked state, the unauthorized appliance may receive power. Conversely, if the outlet is in a locked state, the unauthorized appliance will not unlock the outlet, and as such will not receive power. Accordingly, the non-volatile memory may be employed to mitigate communication between the outlet and the server for all identifiers that are stored in the memory local to the outlet.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction system. For the purposes of this description, a computer-usable or computer readable medium can be any apparatus that can contain, store, communicate, or transport the program for use by or in connection with the instruction system, apparatus, or device.

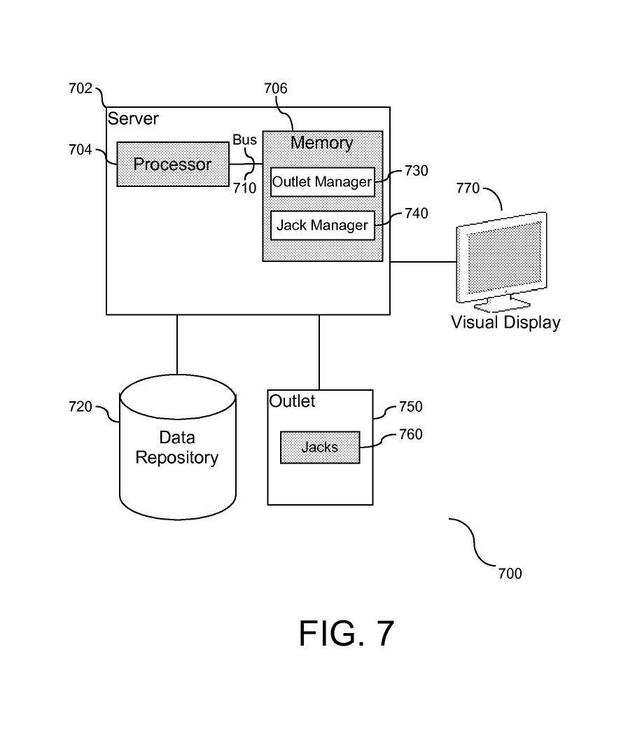

FIG. 7 is a block diagram (700) illustrating placement of an outlet manager and its associated modules in a computer system. The illustration shows a computer system (702), in the form of a management server, with a processor unit (704) coupled to memory (706) by a bus structure (710). Although only one processor unit is shown, in one embodiment, the computer system (702) may include more processor units in an expanded design. The computer system (702) is in communication with a data repository (720).

An outlet manager (730) is provided local to the system to support the functionality of one or more outlets. More specifically, the outlet manager (730) functions as an interface between an outlet (750) and storage component (720), which retains a list of outlet identifiers approved for management. As shown herein, the outlet manager (730) is local to memory (706). In one embodiment, a jack manager (740) may be provided to function as an interface between individual outlet jacks (760) and storage component (720), which retains a list of jack identifiers approved for management. The outlet manager (730) and the jack manager (740) provide the functionality to manage delivery of power to an outlet and/or jack within the system.

As shown herein, the managers (730) and (740) each reside in memory (706) local to the computer system (702). In one embodiment, the managers (730) and (740) may reside as hardware tools external to local memory (706), or they may be implemented as a combination of hardware and software. Similarly, in one embodiment, the managers (730) and (740) may be combined into a single functional item that incorporates the functionality of the separate items. Furthermore, as shown herein, each of the managers (730) and (740) are local to the management server (702). However, in one embodiment, they may be collectively or individually distributed across a network of computer system and function as a unit to embody the functionality of individual managers for individual outlets and/or jacks. The server (702) is provided in communication with a visual display (770) to convey a visual representation of the state of the outlet(s) and/or jack(s) in the system. Accordingly, the managers (730) and (740) may be implemented as software tools, hardware tools, or a combination of software and hardware tools for managing the functionality of an outlet and/or jack.

Embodiments within the scope of the present invention also include articles of manufacture comprising program storage means having encoded therein program code. Such program storage means can be any available media which can be accessed by a general purpose or special purpose computer. By way of example, and not limitation, such program storage means may include RAM, ROM, EEPROM, CD-ROM, DVD, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or processing program code will include at least one processor coupled directly or indirectly to memory elements through a system bus. The memory elements can include local memory employed during actual processing of the program code, bulk storage, and cache memories which provide temporary storage of at least some program code in order to reduce the number of times code must be retrieved from bulk storage during processing.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening non-public or public networks.

The software implementation can take the form of a computer program product accessible from a computer-usable or computer-readable medium providing program code for use by or in connection with a computer or any instruction processing system.

### Advantages Over the Prior Art

The modified outlet and/or jack provides varying states of operation, all of which control delivery of power to the outlet and/or associated jack. More specifically, in contrast to a conventional electrical outlet, the modified outlet does not continuously deliver power from a power source. Rather, depending on the state of the outlet, power is delivered to the outlet following verification of a valid set of connectors. This prevents injuries associated with insertion of non-connectors into a socket. At the same time, power may not be merely delivered to a jack in communication with the outlet waiting for insertion of an authenticated set of connectors. Power is delivered to the jack following verification and authentication of the connectors.

### Alternative Embodiments

It will be appreciated that, although specific embodiments of the invention have been described herein for purposes of illustration, various modifications may be made without departing from the spirit and scope of the invention. In particular, in one embodiment the physical outlet may be configured with one or more addressable jacks, with each jack being independently in communication with the non-volatile memory of the outlet and/or the server. Upon insertion of an appliance plug into a jack, it is the identifier of the jack with respect to the plug that is verified local to the outlet. Following a verification of the appliance plug, the outlet circuit is completed to enable the circuit to be completed and deliver power to the received plug. Accordingly, the scope of protection of this invention is limited only by the following claims and their equivalents.

We claim:

1. A method for controlling delivery of electrical power to a multi-mode electrical outlet, comprising:
a server in communication with an array of outlets across a communication interface;
configuring each outlet in the array of outlets with a unique outlet identifier, with each outlet having at least one jack;
configuring each jack in each outlet with a unique jack identifier;
communicating to the server when an electrical appliance has been received by at least one of the outlets;
the outlet authenticating the received electrical appliance with the server; and
in response to a positive authentication by the server, changing the state of the outlet through the communication interface.

2. The method of claim 1, further comprising the jack in communication with the outlet authenticating the receiving electrical appliance with the server.

3. The method of claim 2, further comprising returning a status identifier of the individual jack to the server.

4. The method of claim 1, further comprising the interface in communication with the server providing a visual representation of the state of all jacks and all of the outlets in the array.

5. The method of claim 1, further comprising the server sending key events to at least one specified outlet based upon a predetermined time-based event.

6. The method of claim 1, wherein the communication interface employs a medium selected from the group consisting of: wired and wireless.

7. The method of claim 1, further comprising embedding a plug identifier with the plug and communicating the plug identifier to the server.

8. The method of claim 7, wherein the plug identifier is an RFID tag.

9. The method of claim 8, further comprising communicating a plug insertion notification event to the server upon attachment of the plug to a jack, including communicating the plug identifier and the identifier of the jack, and communicating a plug removal notification event to the server upon removal of the plug from a jack, including communicating the plug identifier and the identifier of the jack.

10. The method of claim 1, further comprising storing a plug identifier in non-volatile memory local to the outlet, and comparing the plug identifier to identifiers stored in memory.

11. A system comprising:
an array of multi-mode electrical outlets;
a server in communication with the array across a communication interface;
an outlet identifier for each outlet in the array;
at least one jack provided for each outlet in the array;
a jack identifier for each jack provided in each outlet;
a communication interface local to the outlet to send a communication to the server upon receipt of an electrical appliance local to the outlet;
an outlet manager local to the server to receive the communication and to authenticate the received appliance with the server; and
a state of the outlet changed in response to authentication of the received appliance.

12. The system of claim 1, further comprising a jack manager local to the server to receive the communication and to authenticate the received appliance with the server, and the state of the jack changed in response to authentication of the received appliance.

13. The system of claim 12, further comprising a status identifier of the jack returned to the server.

14. The system of claim 11, further comprising a visual display to convey a visual representation of the jacks and the array of outlets.

15. The system of claim 11, further comprising key events sent from the server to at least one of the outlet based upon a pre-determined time-based event.

16. The system of claim 11, wherein the communication interface employs a medium selected from the group consisting of: wired and wireless.

17. The system of claim 11, further comprising a plug identifier local to the appliance, and communication of the plug identifier across the communication interface.

18. The system of claim 17, wherein the plug identifier is a radio frequency identifier tag.

19. The system of claim 18, further comprising a plug insertion notification event communicated to the server upon receipt of the plug by the jack, including communication of the plug identifier and the jack identifier, and communication of a plug removal notification event to the server upon removal of the plug from the jack, including the plug identifier and the jack identifier.

20. The system of claim 11, further comprising non-volatile memory local to the outlet to store a plug identifier, and a manager to compare the plug identifier to identifiers stored local to the non-volatile memory.
